(19) United States
(12) Patent Application Publication
(10) Pub. No.: US 2016/0326003 A1
(43) Pub. Date: Nov. 10, 2016

(54) HYDROPHOBIC FINE WET SILICA, METHOD FOR PRODUCING SAME, AND ANTIFOAMING AGENT

(71) Applicant: SAN NOPCO LTD., Kyoto-shi (JP)

(72) Inventor: Motoyoshi ISHIZUKA, Kyoto-shi (JP)

(73) Assignee: SAN NOPCO LTD., Kyoto-shi (JP)

(21) Appl. No.: 15/110,298

(22) PCT Filed: Jan. 15, 2015
(86) PCT No.: PCT/JP2015/050874

§ 371 Date: Jul. 7, 2016

(30) Foreign Application Priority Data
Jan. 31, 2014 (JP) 2014-017972

(51) Int. Cl. C01B 33/18; C09D 7/12; B01D 19/04; C09C 1/30

(52) U.S. Cl. CPC C01B 33/18; C09C 1/3018; C09C 1/3063; C09D 7/1225; C09D 7/1275; C09D 7/1283; B01D 19/0409; C01P 2004/62; C01P 2004/54; C01P 2004/61

(57) ABSTRACT

There is provided hydrophobic silica that will cause no deterioration in the gloss of resin or of a coating film even when having been applied as a wear resistance-improver or a mechanical strength enhancer for resin or as a fluidizing agent for powder paint or the like and that will cause no deterioration in the gloss of a resulting coating film even when having been applied to a defoaming agent. There is provided hydrophobic particulate wet process silica resulting from subjecting hydrophilic wet process silica to hydrophobization treatment and milling treatment. The number-average particle diameter (Dn) is 0.1 to 1 μm and the M value is 50 to 80. The milling treatment is preferably wet milling treatment. The hydrophobization treatment is preferably wet hydrophobization treatment. The ratio of the volume-average particle diameter (Dv) to the number-average particle diameter (Dn) (Dv/Dn) is preferably 1 to 4.

### TECHNICAL FIELD

The present invention relates to hydrophobic particulate wet process silica, methods for the production thereof, and defoaming agents.

### BACKGROUND ART

Hydrophobic silica is used for wear resistance improvers or mechanical strength enhancers for rubber or resin; fine powder type fluidizing agents for electrophotographic toner, powder paint, or the like; carriers for agrochemicals or catalysts; stabilizers for liquid cosmetics; defoaming agents for industrial use and antiblocking agents for resin film; or the like.

Heretofore, in order to provide hydrophobic silica having high hydrophobicity for attaining improvement in antiphotoaging performance or improvement in water resistance and oil resistance of common paint; improvement in anti-stain (shell) attachment performance of ship bottom paint; improvement in surface slipping property or wear resistance and reinforcement of mechanical strength of rubber or resin; improvement in flowability of toner in electrostatic copiers; improvement in defoaming performance of defoaming agents; and improvement in antiblocking performance of paper, there has been proposed hydrophobic silica obtainable by treating hydrophilic silica with an epoxyalkylsilane compound and further treating it with a hydrophobizing agent including one or more species selected from carboxylic acid compounds, specific monohydric alcohols, and specific alkylbenzene dimers (Patent Document 1).

### CITATION LIST

### Patent Document

Patent Document 1: JP 2008-105918 A

### SUMMARY OF INVENTION

### Problems to be Solved by the Invention

However, such conventional hydrophobic silica has a problem that the surface gloss of resin or a coating film deteriorates when it is applied as a wear resistance improver or a mechanical strength enhancer for resin or as a fluidizing agent for powder paint or the like. In addition, it also has another problem that when it is applied to a defoaming agent, deterioration will occur in the gloss of a coating film obtained by applying a paint including the defoaming agent.

The object of the present invention is to provide hydrophobic silica that will cause no deterioration in the gloss of resin or of a coating film even when having been applied as a wear resistance improver or a mechanical strength enhancer for resin or as a fluidizing agent for powder paint or the like and that will cause no deterioration in the gloss of a resulting coating film even when having been applied to a defoaming agent.

### Means for Solving the Problems

The gist of the feature of the hydrophobic particulate wet process silica of the present invention is that the silica is hydrophobic particulate wet process silica resulting from subjecting hydrophilic wet process silica to hydrophobization treatment and milling treatment, wherein the number-average particle diameter is 0.1 to 1 μm and the M value is 50 to 80.

The gist of the feature of the method of the present invention for producing hydrophobic particulate wet process silica is that the method is a method for producing the above-mentioned hydrophobic particulate wet process silica, the method including:

process (A) including hydrophoization treatment step (1) of obtaining hydrophobic wet process silica by subjecting hydrophilic wet process silica to hydropholsization treatment and milling step (2) of obtaining hydrophobic particulate wet process silica by milling the hydrophobic wet process silica; or

process (B) including milling step (3) of obtaining hydrophilic particulate wet process silica by milling hydrophilic wet process silica and hydrophobization treatment step (4) of obtaining hydrophobic particulate wet process silica by subjecting the hydrophilic particulate wet process silica to hydrophobization treatment.

The gist of the feature of the defoaming agent of the present invention is that the agent includes the above-mentioned hydrophobic particulate wet process silica or hydrophobic particulate wet process silica obtained using the above-mentioned production method, and an oily component.

### Advantageous Effects of Invention

The hydrophobic particulate wet process silica of the present invention does not cause deterioration in gloss of resin or of a coating film even when it is applied as a wear resistance improver or a mechanical strength enhancer for resin or as a fluidizing agent for power paint or the like, and it does not cause deterioration in gloss of a resulting coating film even when it is applied to a defoaming agent (hereinafter, the property that gloss does not decrease is called gloss property).

The method of the present invention for producing hydrophobic particulate wet process silica is suitable for producing the above-mentioned hydrophobic particulate wet process silica and the above-mentioned hydrophobic particulate wet process silica can be produced easily therewith.

The defoaming agent of the present invention does not cause deterioration in gloss of a coating film because of its inclusion of the above-mentioned hydrophobic particulate wet process silica or hydrophobic particulate wet process silica obtained using the above-mentioned production method and, accordingly, it is suitable as a defoaming agent to be used for the paint industry, the ink industry, the pulp and paper industry, etc.

### MODE FOR CARRYING OUT THE INVENTION

Hydrophilic wet process silica includes silica produced by the precipitation process (henceforth referred to as precipitated silica) and silica produced by the gel process (henceforth gel-processed silica). Of these, precipitated silica is preferred. Especially in the case of applying the hydrophobic particulate wet process silica of the present invention to a defoaming agent, the defoaming property is more improved. It is believed that this is because the use of precipitated silica increases irregularities on the surface of hydrophobic particulate wet process silica, leading to increased easiness of the defoaming agent to go into a foam film.

Precipitated silica is silica obtainable by neutralizing sodium silicate with an acid under a neutral to alkaline environment and filtering and drying the resulting precipitate, and gel-process silica is silica obtainable by neutralizing sodium silicate with an acid under an acidic environment and filtering and drying the resulting precipitate.

Hydrophilic precipitated silica and hydrophilic gel-processed silica are readily commercially available, and the following trade names can be cited, for example.

### <Hydrophilic Precipitated Silica>

Nipsil series {available from Tosoh Silica Corporation; “Nipsil” is a registered trademark of Tosoh Silica Corporation}, Sipernat series {available from Evonik Degussa Japan Co., Ltd.; “Sipernat” is a registered trademark of Evonik Degussa GMBH.}, Carplex series {available from DSL. Japan Co., Ltd.; “Carplex.” is a registered trademark of DSL. Japan Co., Ltd.}, FINESIL series {available from Tokuyama Corporation; “FINESIL” is a registered trademark of Tokuyama Corporation}, TOKUSIL {available from Tokuyama Corporation; “TOKUSIL” is a registered trademark of Tokuyama Corporation}, Zeosil {available from Rhodia; “Zeosil” is a registered trademark of Rhodia Chimie}, MIZUKASIL series {available from Mizusawa Industrial Chemicals, Ltd.; “MIZUKASIL” is a registered trademark of Mizusawa Industrial Chemicals, Ltd.}, and the like.

### <Hydrophilic Gel-Processed Silica>

Carplex series, SYLYSIA series {available from Fuji Silysia Chemical Ltd.; “SYLYSIA” is a registered trademark of YUGENKAISHA Y.K.F.}, Nipgel series {available from Tosoh Silica Corporation; “Nipgel” is a registered trademark of Tosoh Silica Corporation}, MIZUKASIL series {available from Mizusawa Industrial Chemicals, Ltd.; “MIZUKASIL” is a registered trademark of Mizusawa Industrial Chemicals, Ltd.}, and the like.

The hydrophobic particulate wet process silica of the present invention is not limited regarding the order of hydrophobization treatment and milling treatment, etc. as long as hydrophilic wet process silica has been subjected to hydrophobization treatment and milling treatment. That is, it is permitted to perform one of the hydrophobization treatment and the milling treatment in advance and perform the other thereafter, or it is also permitted to perform the hydrophobization treatment and the milling treatment in parallel. The milling treatment is preferably wet milling treatment. The hydrophobization treatment is preferably wet hydrophobization treatment. The details of hydrophobization treatment and milling treatment suitable for obtaining the hydrophobic particulate wet process silica of the present invention are described below as a method for producing hydrophobic wet process silica.

Use of hydrophobic we process silica prepared by subjecting hydrophilic wet process silica to hydrophobization treatment instead of subjecting hydrophilic wet process silica to hydrophobization treatment and milling treatment renders hydrophobization treatment unnecessary and only milling treatment should have been performed. If hydrophobic wet process silica is used, it may be further subjected to hydrophobization treatment in order to adjust its M value.

The hydrophobic wet process silica prepared by subjecting hydrophilic wet process silica to hydrophobization treatment may be commercially available and the following hydrophobic wet process silica can be cited, for example.

Nipsil SS series, Sipernat D and C series, and SYLOPHOBIC series {available from Fuji Silysia Chemical Ltd., “SYLOPHOBIC” is a registered trademark of Fuji Silysia Chemical Ltd.}, etc.

The number-average particle diameter (Dn; μm) of the hydrophobic particulate wet process silica of the present invention is 0.1 to 1, and from the viewpoint of gloss property, it is preferably 0.2 to 0.6, more preferably 0.2 to 0.4.

The number-average particle diameter is determined by use of a laser diffraction particle size analyzer in accordance with JIS Z8825: 2013 (corresponding to ISO 13320) {e.g., Microtrac series manufactured by Leeds & Northrup and Partica LA series manufactured by HORIBA, Ltd.}; it is determined as a 50% cumulative number-average particle diameter by preparing a dispersion liquid to be measured by adding a sample to be measured to 1000 parts by weight of 2-propanol {purity=99% by weight or more} so as to attain a concentration of the sample to be measured of 0.1% by weight, performing measurement at a measuring temperature of 25±5° C., and then determining the number-average particle diameter by using a refractive index of 2-propanol of 1.3749 and a literature value (“A GUIDE FOR ENTERING MICROTRAC “RUN INFORMATION” (F3) DATA”, produced by Leeds & Northrup) as the refractive index of the sample to be measured.

The ratio of the volume-average particle diameter (Dv) to the number-average particle diameter (Dn) (Dv/Dn) of the hydrophobic particulate wet process silica of the present invention is preferably 1 to 4, more preferably 1 to 3 from the viewpoint of gloss property.

The volume-average particle diameter can be measured in a similar manner as the number-average particle diameter and it is determined as a 50% cumulative volume-average particle diameter.

The M value (methanol wettability) of the hydrophobic particulate wet process silica of the present invention is 50 to 80, and from the viewpoint of gloss property, it is preferably 55 to 76.

The M value (methanol wettability) is a characteristic value indicating the degree of hydrophobization treatment of the surface of a powder: a higher M value indicates lower hydrophilicity and higher degree of hydrophobization treatment (higher hydrophobicity), and the M value is represented by the volume ratio of methanol in a minimal amount required for uniformly dispersing the powder (particles to be measured) in a water/methanol mixed solution and can be determined by the following method.

### <Method of Calculating M Value>

Water/methanol mixed solutions with methanol concentrations varied in 5% by volume intervals are prepared, and 5 ml of each of them is put into a 10 ml test tube. Subsequently, 0.2 g of a sample to be measured is put in and the test tube is sealed, inverted 20 times, and then allowed to stand. Then, aggregates are observed and the methanol concentration (% by volume) of the mixed solution having the minimum methanol concentration among the mixed solutions which contain no aggregates and in which the sample to be measured has been wetted entirely and mixed homogeneously is defined as an M value (methanol wettability).

While the hydrophobic particulate wet process silica of the present invention is not limited regarding the method for the production thereof as long as hydrophilic wet process silica has been subjected to hydrophobization treatment and milling treatment, the method for producing the hydmphobic particulate wet process silica of the present invention is preferably a method including: process (A) including hydrophobization treatment step (1) of obtaining hydrophobic wet process silica by subjecting hydrophilic wet process silica to hydrophobization treatment and milling step (2) of obtaining hydrophobic particulate wet process silica by milling the hydrophobic wet process silica; or process (B) including milling step (3) of obtaining hydrophilic particulate wet process silica by milling hydrophilic wet process silica and hydrophobization treatment step (4) of obtaining hydrophobic particulate wet process silica by subjecting the hydrophilic particulate wet process silica to hydrophobization treatment.

Methods known in the art can be applied in hydrophobization treatment; for example, the following <Hydrophobization Treatment Method 1> and <Hydrophobization Treatment Method 2> can be applied.

### <Hydrophobization Treatment Method 1>

A method including: stirring an organic solvent and/or an oily component together with hydrophilic wet process silica or hydrophilic particulate wet process silica and a hydrophobizing agent, and at the same time adsorbing or reacting the hydrophobizing agent to the surface of the hydrophilic wet process silica or the hydrophilic particulate wet process silica (wet hydrophobization treatment).

### <Hydrophobization Treatment Method 2>

A method including: stirring hydrophilic wet process silica or hydrophilic particulate wet process silica and a hydrophobizing agent, and at the same time adsorbing or reacting the hydrophobizing agent to the surface of the hydrophilic wet process silica or the hydrophilic particulate wet process silica (dry hydrophobization treatment).

As the organic solvent, hydrocarbon solvents (toluene, xylene, etc.), glycol ether solvents (diethylene glycol monoethyl ether acetate, triethylene glycol dimethyl ether, etc.), ketone solvents (methyl ethyl ketone, methyl isobutyl ketone, etc.), and so on can be used.

As the oily component, vegetable oils, mineral oils, ester oils, nonreactive silicone oils, and so on can be used.

Examples of the vegetable oils include avocado oil, camellia oil, turtle oil, macadamia nut oil, corn oil, mink oil, olive oil, rapeseed oil, egg oil, sesame oil, persic oil, wheat germ oil, sasanqua oil, castor oil, linseed oil, safflower oil, cottonseed oil, perilla oil, soybean oil, peanut oil, tea seed oil, kaya oil, rice bran oil, paulownia oil, Japanese tung oil, jojoba oil, and germ oil.

The mineral oils include hydrocarbon oils obtained through refining of petroleum and refined mineral oils obtained by hydrogenating them, and lubricating oils, spindle oils, paraffin oils {liquid paraffins (n-paraffin, isoparaffin, etc.), ozokerite, squalene, pristane, paraffin, ceresin, squalene, vaseline, etc.} and mixtures thereof can be used.

The kinematic viscosity (40° C.; mm²/s) of the mineral oils is preferably 4 to 146, more preferably 4 to 30, particularly preferably 10 to 28, and most preferably 15 to 25. When the kinematic viscosity is within such ranges, the gloss property is further improved.

Examples of the ester oils include esters of fatty acids and alcohols, and examples thereof specifically include isopropyl myristate, cetyl octanoate, octyldodecyl myristate, isopropyl palmitate, butyl stearate, hexyl laurate, myristyl myristate, decyl oleate, hexyldecyl dimethyloctanoate, cetyl lactate, myristyl lactate, lanoline acetate, isocetyl stearate, isocetyl isostearate, cholesteryl 12-hydroxystearate, ethylene glycol di-2-ethylhexanoate, dipentaerythritol fatty acid ester, N-alkylglycol monoisostearate, neopentyl glycol dicaprate, diisostearyl malate glycerin di-2-heptylundecanoate, trimethylolpropane tri-2-ethylhexanoate, trimethylolpropane triisostearate, pentaerythritol tetra-2-ethylhexanoate, glycerin tri-2-ethylhexanoate, trimethylolpropane triisostearate, cetyl 2-ethylhexanoate, 2-ethylhexyl palmitate, glycerin trimyristate, glycerin tri-2-heptylundecanoate, castor oil fatty acid methyl ester, oleyl oleate, cetostearyl alcohol, acetoglyceride, 2-heptylundecyl palmitate, diisobutyl adipate, N-lauroyl-L-glutamic acid-2-octyldodecyl ester, di-2-heptylundecyl adipate, ethyl laurate, di-2-ethylhexyl sebacate, 2-hexyldecyl myristate, 2-hexyldecyl palmitate, 2-hexyldecyl adipate, and diisopropyl sebacate.

Examples of nonreactive silicone oils include dimethylpolysiloxane aryl-modified polysiloxanes (the number of carbon atoms of the aryl group is 6 to 10), alkyl-modified polysiloxanes (the number of carbon atoms of the modified alkyl group is 2 to 6), 5 to 20-mer cyclic silicones, and polyether-modified polysiloxane.

As the dimethylpolysiloxane, one having a kinematic viscosity (at 25° C.) of 1 to 500,000 mm²/s can be used, for example.

The kinematic viscosity (at 25° C.; mm²/s) of dimethylpolysiloxane is preferably 10 to 50,000, more preferably 20 to 5,000, and particularly preferably 50 to 3,000. When the kinematic viscosity is within such ranges, the gloss property is further improved.

As the aryl-modified polysiloxane and the alkyl-modified polysiloxane, one having a kinematic viscosity (at 25° C.) of 1 to 10,000 mm²/s can be used, for example.

As the 5 to 20-mer cyclic silicones, decamethylcydopentasiloxane, dodecamethylcyclohexasiloxane, and tetracontamethyl cydoeicosasiloxane can be used, for example.

As the polyether-modified polysiloxane, one having a kinematic viscosity (at 25° C.) of 1 to 10000 mm²/s and an HLB of 2 to 5 can be used, for example.

The HLB is a concept that indicates the balance between hydrophilic groups and hydrophobic groups in a molecule, and the HLB value of polyether-modified polysiloxane can be calculated as follows using the “Method for Measuring HLB by Emulsification Test” disclosed, in “Properties and Applications of Surfactants”, pp. 89-90, (authored by Kariyone Takao, publisher: Saiwai Shobo, published Sep. 1, 1980).

### <Method for Measuring HLB of Polyether-Modified Polysiloxane by Emulsification Test>

A polyether-modified polysiloxane (X) whose HLB is unknown and an emulsifier (A) whose HLB is known are mixed in different, ratios and oils (B) with known HLB are emulsified. The HLB of the polyether-modified polysiloxane (X) is calculated from the mixing ratio achieved when the thickness of the emulsified layer is the maximum by using the following equation.

HLB_{X}={(HLB_{B})+(W_{A}+W_{X})−(W_{A}×HLB_{A})}/W_{X}

W_{A} is the weight fraction of the emulsifier (A) based on the total weight of the polyether-modified polysiloxane (X) and the emulsifier (A), W_{X} is the weight fraction of the polyether-modified polysiloxane (X) based on the total weight of the polyether-modified polysiloxane (X) and the emulsifier (A), HLB_{A} is the HLB of the emulsifier (A), HLB_{B} is the HLB of the oil (B), and HLB_{X} is the HLB of the polyether-modified polysiloxane (X).

Of hydrophobization treatments, Hydrophobization Treatment Method 1 (wet hydrophobization treatment) is preferable in terms of gloss property, and a method of performing treatment while stirring an oily component, hydrophilic wet process silica or hydrophilic particulate wet process silica, and a hydrophohizing agent is more preferable.

Of oily components, mineral oils and silicone oils are preferable, and mineral oils and dimethylpolysiloxane are more preferable.

The mineral oil and dimethylpolysioxine are readily commercially available and examples thereof include the following trade names.

### <Mineral Oil>

COSMO SC22 (21 mm²/s), COSMO SP10 (10 mm²/s), COSMO RC spindle oil (10 mm²/s), COSMO RB spindle oil (15 mm²/s), COSMO NEUTRAL 150 (32 mm²/s), COSMO PURESPIN G (21 mm²/s), and COSMO PURESPIN E (5 mm²/s) (available from COSMO OIL LUBRICANTS Co., Ltd.; “COSMO” is a registered trademark of COSMO OIL Co., Ltd.); NISSEKI SUPER OIL C (93 mm²/s), NISSEKI SUPER OIL D (141 mm²/s), and NISSEKI SUPER OIL B (54 mm²/s) (available from Nippon Oil Corporation); STANOL 43N (27 mm²/s), STANOL 52 (56 mm²/s), STANOL 69 (145 nun²/s), STANOL 35 (9 mm²/s), and STANOL LP35 (11 mm²/s) (available from ESSO Petroleum Co., Ltd.); and FUKKOL SH SPIN (9 mm2/s), FUKKOL NT100 (21 mm²/s), FUKKOL NT150 (28 mm²/s), FUKKOL NT200 (39 mm²/s), FUKKOL NT60 (10 mm²/s), and FUKKOL ST MACHINE (9 mm²/s) (available from FUJI KOSAN, Co., LTD.; “FUKKOL” is a registered trademark of Nippon Oil Corporation) (the number in parenthesis represents “kinematic viscosity (at 40° C)”).

### <Dimethylpolysiloxane>

KF96-10cs, KF9G-20cs, KF96-30cs, KF96-50cs, KF96-100cs, KF96-200cs, KF96-300cs, KF96-350cs, KF96-500cs, KF96-1,000cs, KF96-3,000cs, KF96-5,000cs, KF96H-6,000cs, KT96H-10,000cs, KF96H-12,500cs, KF96H-30,000cs, KF96H-50,000cs, KF96H-60,000cs, and KF96H-100,000cs (available from Shin-Etsu Chemical Ca, Ltd.); SH200-10cs, SH200-20cs, SH200-50cs, SH200-100cs, SH200-200cs, SH200-350cs, SH200-500cs, SH200-1,000cs, SH200-3,000cs, SH200-5,000cs, SH200-10,000cs, SH200H-12,500cs, SH200H-30,000cs, SH200H -60,000cs, and SH200H-100,000cs (available from Dow Corning Toray Silicone Co., Ltd.); and TSF451-10, TSF451-20, TSF 451-30, TSF451-50, TSF451-100, TSF451-200, TSF451-300, TSF451-350, TSF451-500, TSF451-1000, TSF451-1500, TSF451-2000, TSF451-3000, TSF451-5000, TSF451-6000, TSF4511H-1M, TSF4511H-12500, TSF451H-2M, TTSF451H-3M, TSF451H-5M, TSF451H-6M, and TSF451H-10M (available from GE Toshiba Silicones Co., Ltd.) (the number following hyphen represents “kinematic viscosity (at 25° C.)”; M means×10⁴).

The organic solvent and the oily component may be selected appropriately according to the application of the hydrophobic particulate wet process silica, etc.; one of these may be used or alternatively two or more of them may be used in combination.

Examples of the hydrophobizing agent include halosilanes, alkoxysilanes, fatty acids having 4 to 28 carbon atoms, aliphatic alcohols having 4 to 36 carbon atoms, aliphatic amines having 12 to 22 carbon atoms, and silicone compounds.

Examples of the halosilanes include alkylhalosilanes and arylhalosilanes the alkyl groups or the aryl groups of which have 1 to 12 carbon atoms, and examples thereof include methyltrichlorosilane, dimethyldichlorosilane, trimethylchlorosilane, trimethylbromosilane, ethyltrichlomsilane, dedecyltrichlorosilane, phenyltrichlorosilane, diphenyl dichlorosilane, and tert-butyldimethylchlorosilicane.

Examples of the alkoxysilanes include alkoxysilanes the alkyl groups or aryl groups of which have 1 to 12 carbon atoms and the alkoxy groups of which have 1 to 2 carbon atoms, and examples thereof include methyltrimethoxysilane, dimethyldimethoxysilane, phenyitrimethoxysilane diphenyldimethoxysilane, o-methylphenyltrimethoxysilane p-methylphenyitrimethoxysilane, n-hutyltrimethoxysila.ne, isobutyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, isobutyltriethoxysilane, decyltriethoxysilane, vinyitriethoxysilane, and y-methacryloxypropyltrimethoxysilane.

Examples of the fatty acids having 4 to 28 carbon atoms include butanoic acid, hexanoic acid, lauric acid, stearic acid, oleic acid, behenic acid, and montanic acid.

Examples of the aliphatic alcohols having 4 to 36 carbon atoms include n-butyl alcohol, n-amyl alcohol, n-octanol, lauryl alcohol, stearyl alcohol, and bebenyl alcohol.

Examples of the aliphatic amines having 12 to 22 carbon atoms include dodecylarnine, stearylamine, and oleylamine.

Examples of the silicone compounds include dimethylpolysiloxane, aryl-modified polysiloxanes (the aryl group has 6 to 10 carbon atoms), alkyl-modified polysiloxanes (the alkyl group has 2 to 6 carbon atoms), hydroxy group-modified polysiloxanes, amino group-modified polysiloxanes, 3 to 4-mer cyclic silicones, and methylhydmgenpolysiloxane.

As the dimethylpolysiloxane, the aryl-modified polysiloxane and the alkyl-modified polysiloxane, ones the same as those of the oily component can be used.

As the hydroxy group-modified polysiloxanes, the amino group-modified polysiloxanes and the methylhydrogenpolysiloxane, one having a kinematic viscosity (at 25° C.) of 1 to 10,000 mm²/s and a functional group equivalent of 300 to 8,000 g/mol can be used, for example.

As the hydrophobizing agent to be used for hydrophobization treatment, there can be used coupling agents known in the art (silane coupling agents other than those mentioned above, titanate coupling agents, zicoaluminate coupling agents, and the like) as well as those mentioned above.

Of these hydrophobizing agents, halosilanes, alkoxysilanes and silicone compounds are preferred from the viewpoint of gloss property, silicone compounds are more preferred, and dimethylpolysiloxane and methyllaydrogenpolysiloxane are particularly preferred. It is believed that these are preferred because the use of such a hydrophobizing agent allows the hydrophobization treatment to be performed more certainly and uniformly.

In the wet hydrophobization treatment, the following <Mixing Method 1> to <Mixing Method 3> etc. can be applied as the method of mixing hydrophilic wet process silica or hydrophilic particulate wet process silica, an organic solvent and/or an oily component, and a hydrophobizing agent.

### <Mixing Method 1>

A method including adding hydrophilic wet process silica or hydrophilic particulate wet process silica, an organic solvent andlor an oily component, and a hydrophobizing agent to a container simultaneously, and then mixing them uniformly.

### <Mixing Method 2>

A method including adding an organic solvent and/or an oily component and a hydrophobizing agent to a container containing hydrophilic wet process silica or hydrophilic particulate wet process silica, and then mixing them uniformly.

### <Mixing Method 3>

A method including adding hydrophilic wet process silica or hydrophilic particulate wet process silica to a container containing a hydrophobizing agent and an organic solvent and/or an oily component, and then mixing them uniformly.

Of these, <Mixing Method 1> and <Mixing Method 3> are preferable from the viewpoint to gloss property, and <Mixing Method 3> is more preferable.

In mixing the organic solvent and/or the oily component, the hydrophilic wet process silica or the hydrophilic particulate wet process silica, and the hydrophobizing agent, mixers known in the art (blade stirrers, high speed rotation type homomixers high pressure homogenizers, dissolvers, ball mills, kneaders, sand mills, triple roll mills, ultrasonic dispersers, planetary mixing dispersers (planetary mixers, triple planetary mixer, etc.), and so on) can be used.

Of these mixers, blade stirrers, high speed rotation type homomixers, high pressure homogenizers, and dissolvers are preferable from the viewpoint of dispersibility and gloss property, high speed rotation type homomixers, high pressure homogenizers, and dissolvers are more preferable, and high speed rotation type homomixers are particularly preferable.

In the hydrophobization treatment method 2 (dry hydrophobization treatment), stirrers known in the art can be used as a stirrer and, for example, vertical single screw powder stirrers {Henschel mixer (manufactured by Mitsui Mining Co., Ltd.; “Henschel mixer” is a registered trademark of Mitsui Mining Co., Ltd.), universal mixers, grinding machines, etc.}, horizontal single screw stirrers (ribbon mixer, etc.), and so on can be used.

In the hydrophobization treatment, heating may be performed. In the case of performing heating treatment, the heating temperature (° C.) is preferably 100 to 400, more preferably 200 to 300.

The hydrophobization treatment can be carried out in the presence of a reaction catalyst (sulfuric acid, nitric acid, hydrochloric acid, hydroxyacetic acid, trifluoroacetic acid, p-nitrobenzoic acid, potassium hydroxide, lithium hydroxide, etc.).

The amount (% by weight) of the hydrophobizing agent to be used is preferably 2 to 40, more preferably 10 to 30 based on the weight of the hydrophilic wet process silica or the hydrophilic particulate wyt process silica. When the amount is within such ranges, the gloss property is further improved.

In the hydrophobization treatment method 1 (wet hydrophobization treatment) the content (% by weight) of the hydrophilic wet process silica or the particulate wet process silica is preferably 1 to 20, more preferably 5 to 15 based on the total weight of the hydrophilic wet process silica or the hydrophilic particulate wet process silica, the organic solvent and the oily component. The content (% by weight) of the organic solvent and the oily component is preferably 80 to 99, more preferably 85 to 95 based on the total weight of the hydrophilic wet process silica or the hydrophilic particulate wet process silica, the organic solvent and the oily component.

A method known in the art can be used in the milling treatment; for example, the following <Milling Method 1> and <Milling Method 2> can be applied.

### <Milling Method 1>

A method including milling hydrophilic wet process silica or hydrophobic wet process silica in a powdered state (dry milling method).

### <Milling Method 2>

A method including milling hydrophilic wet process silica or hydrophobic wet process silica in an organic solvent and/or an oily component (wet milling method).

Of these milling treatments, Milling Method 2 (wet milling method) is preferable from the viewpoint of gloss property.

The organic solvent and the oily component to be used in the wet milling method are as those described above and preferable ones are also the same.

The number-average particle diameter (μm) of the hydrophilic wet process silica or the hydrophobic wet process silica is preferably 1 to 50, more preferably 2 to 20.

The particle diameter ratio (Dn/D0) of the number-average particle diameter (Dn) of the hydrophilic particulate wet process silica, or the hydrophobic particulate wet process silica to the number-average particle diameter (D0) of the hydrophilic wet process silica or the hydrophobic wet process silica is preferably 0.01 to 0.2.

In Milling Method 1 (dry milling method), dry milling devices known in the art can be used dry medium type milling devices {dry bead mill, dry ball mill, etc.} and air flow type milling devices {jet mill, etc.} can be used, for example.

In Milling Method 2 (wet milling method), wet milling devices known in the art can be used; wet medium type milling devices {bead mill, sand grinder, colloid mill, Attritor (manufactured by NIPPON COKE & ENGINEERING CO., LTD.; “Attritor” is a registered trademarks of NIPPON COKE & ENGINEERING CO., LTD.), DISPERMAT (manufactured by VMA-GETAMANN GMBH), etc.}, high pressure injection type milling devices {Nanomizer (manufactured by Yoshida Machinery Co., Ltd.: “Nanomizer” is a registered trademark of SG Engineering Inc.), Star Burst (manufactured by Sugino Machine Limited; “Star Burst” is a registered trademark of Sugino Machine Limited), Gaulin Homogenizer (manufactured by APV), etc.} can be used, for example.

In the wet milling method, the content (% by weight) of the hydrophilic wet process silica or the hydrophobic wet process silica is preferably 1 to 25, more preferably 5 to 20 based on the total weight of the organic solvent, the oily component, and the hydrophilic wet process silica or the hydrophilic wet process silica. The content (% by weight) of the organic solvent and the oily component is preferably 75 to 99, more preferably 80 to 95 based on the total weight of the organic solvent, the oily component, and the hydrophilic wet process silica or the hydrophilic, wet process silica.

In Method (A) the hydrophobization treatment step (1) is preferably step (1-1) of dispersing hydrophilic wet process silica in an organic solvent and/or an oily component (preferably only an oily component), thereby obtaining a dispersion liquid, and then performing hydrophobization treatment, thereby obtaining hydrophobic wet process silica. In addition, the milling step (2) is preferably step (2-1) of milling hydrophobic wet process silica in an organic solvent, and/or an oily component (preferably only an oily component), thereby obtaining hydrophobic particulate wet process silica.

In Method (B), the milling step (3) is preferably step (3-1) of dispersing hydrophilic wet process silica in an organic solvent and/or an oily component (preferably only an oily component), thereby obtaining a dispersion liquid, and then milling hydrophilic wet process silica in an organic solvent and/or an oily component (preferably only an oily component), thereby obtaining hydrophilic particulate wet process silica. In addition, the hydrophobization treatment step (4) is preferably step (4-1) of subjecting hydrophilic particulate wet process silica to hydrophobization treatment in an organic solvent and/or an oily component (preferably only an oily component), thereby obtaining hydrophobic particulate wet process silica.

A classification step may be provided after and/or before each step.

As the classification step, wet classification methods and dry classification methods, etc. known in the art can be applied.

When having performed at least one of hydrophobization treatment and milling treatment in an organic solvent and/or an oily component (wet hydrophobization treatment, wet milling treatment), there may be provided an isolation step of isolating hydrophobic particulate wet process silica or hydrophilic particulate wet process silica from a dispersion liquid containing the hydrophobic particulate wet process silica or the hydrophilic particulate wet process silica.

The isolation step can be performed using a method known in the are (centrifugation, filtration, decantation, etc.).

Moreover, a drying step may be provided after the isolation step. A method known in the art (e,g., heating at 30 to 150° C. for 10 to 120 minutes) may be applied to the drying step.

The hydrophobic particulate wet process silica of the present invention does not deteriorate the surface gloss of a resin composition even if it is mixed with resin. Accordingly, it can be preferably used as a wear resistance improver or a mechanical strength enhancer for resin, a fluidizing agent for powder paint and the like, and a defoaming agent for paint because it does not cause deterioration in gloss of a molded article or the surface of a coating film and good appearance can be obtained. Because of being excellent in gloss property as mentioned above, it can be used also as a wear resistance improver or a mechanical strength enhancer for rubber, a stabilizer for cosmetics, and an anti-blocking agent for resin film besides those mentioned above.

When the hydrophobic particulate wet process silica of the present invention and hydrophobic particulate wet process silica obtained by the production method of the present invention (henceforth, these are referred to simply as “hydrophobic particulate wet process silica”) are applied to a defoaming agent, it is good in gloss property and it excels in defoaming performance. Such a defoaming agent is constituted to include “hydrophobic particulate wet process silica” and an oily component.

When “hydrophobic particulate wet process silica” is applied to a defoaming agent, the content (% by weight) of the “hydrophobic particulate wet process silica” is preferably 0.1 to 20, more preferably 1 to 10 based on the weight of the “hydrophobic particulate wet process silica” and an oily component. The content (% by weight) of the oily component is preferably 80 to 99.9, more preferably 90 to 99 based on the weight of the “hydrophobic particulate wet process silica” and the oily component. In such ranges, the gloss property and the defoaming property are further improved.

The oily component to be used for the defoaming agent is as those described above and preferable ones are also the same.

When “hydrophobic particulate wet process silica” is applied to a defoaming agent, the defoaming agent preferably further contains at least one nucleating agent selected from the group consisting of fatty acid metal salt, fatty acid amide, wax, hydrophobic metal oxide, and synthetic resin.

As the nucleating agent, compounds known in the art (e.g., JP-A-2013-144287), etc. can be used. It is noted that the hydrophobic metal oxide does not include “hydrophobic particulate wet process silica” and hydrophobic wet process silica. Examples of the hydrophobic metal oxide include hydrophobic day process silica, hydrophobic alumina, hydrophobic titania and hydrophobic zinc oxide.

Among nucleating agents, waxes and fatty acid amides are preferable from the viewpoint of defoaming property, and so on, and fatty acid amides (e.g., ethylene bisstearylamide, ethylene bispalmitylamide, ethylene bislaurylamide, methylene bisstearylamide, and hexamethylene bisstearylamide) are more preferable, and ethylene bisstearylamide, ethylene bispalmitylamide, and ethylene bismyristylamide are particularly preferable. These amides may be in the form of a mixture of two or more species, and in the case of such a mixture, it is preferred that the above-mentioned preferable species are contained as main components (in at least 40% by weight).

When the defoaming agent contains a nucleating agent, the content (% by weight) thereof is preferably 0.1 to 10, more preferably 0.5 to 5 based on the weight of the “hydrophobic particulate wet process silica” and the oily component. In such ranges, the gloss property and the defoaming property are further improved.

When “hydrophobic particulate wet process silica” is applied to a defoaming agent, the defoaming agent may further contain water. When water is contained, the content (% b weight) thereof is preferably 5 to 70 or 120 to 500, more preferably 10 to 50 or 150 to 250 based on the weight of the “hydrophobic particulate wet process silica” and the oily component. In such ranges, the gloss property is further improved.

When “hydrophobic particulate wet process silica” is applied to a defoaming agent, the defoaming agent may further contain additional components (hydrophilic silica, thickener, mildewproofing agent, antiseptic agent, rust inhibitor, antioxidant, antiskinning agent, etc. disclosed in JP-A-2004-305882), according to necessity.

When the defoaming agent contains additional components, the total content (% by weight) of the additional components is preferably 0.01 to 20, more preferably 0.05 to 10, particularly preferably 0.1 to 1 based on the weight of the “hydrophobic particulate wet process silica” and the oily component.

When “hydrophobic particulate wet process silica” is applied to a defoaming agent, the defoaming agent can be produced by uniformly mixing “hydrophobic particle silica” and an oily component and, according to necessity, a nucleating agent, water andlor additional components. The uniform mixing can be performed by applying a method known in the art.

The defoaming agent of the present invention can be applied to a various types of foamable liquid and it is effective for an aqueous foamable liquid.

The defoaming agent of the present invention can be used preferably as a defoaming agent for the chemical industry, a defoaming agent for the petroleum industry, a defoaming agent for civil engineering and construction, a defoaming agent for ink, a defoaming agent for paint (water-based paint, etc.), and a defoaming agent for various production processes (water-soluble macromolecule dissolution process, a pigment dispersion process, a papermaking process, a fermentation process, an incubation process, a waste water treatment process, a monomer stripping process, a polymer polymerization process, and so on). Of these, it is suitable as a defoaming agent for ink and a defoaming agent for paint (water-based paint, etc.).

While the added amount (% by weight) of the defoaming agent is determined appropriately according to a foaming state, a temperature, a viscosity, etc., it is preferably 0.001 to 10, more preferably 0.005 to 3 based on the weight of the foamable

### EXAMPLES

Hereinbelow, the present invention will be described further in detail with reference to examples, but the present invention is not limited thereto. Unless otherwise indicated, parts mean parts by weight.

### <Measurement, of Volume-Average Particle Diameter and Number-Average Particle Diameter>

The volume-average particle diameter and the number-average particle diameter of hydrophilic wet process silica and hydrophilic particulate wet process silica were measured by the following methods.

A sample (hydrophilic wet process silica) was dispersed in a concentration of 1% by weight in ion-exchanged water {electric conductivity (at 25° C.); 0.1 mS/m; the same applies hereinafter} at an output of 60% for 1 minute by using an ultrasonic disperser (manufactured by Hiel-scher GmbH, ULTRASONIC PROCESSOR MODEL UP 400S; the same applies hereinafter). Subsequently, the volume-average particle diameter and the number-average particle diameter in the dispersion liquid were measured with a laser diffraction/scattering type particle size distribution analyzer (manufactured by HORIBA, Ltd., Partica LA-950) {batch cell type; the index of refraction of the dispersoid 1.45; the index of refraction of the dispersion medium; 1.33 (water); the number of repetition: 15; the concentration of the dispersion liquid of the sample to be measured was adjusted according to necessity by adding the sample to be measured or ion-exchanged water so as to achieve a blue LED transmittance of 89 to 91%}.

The number-average particle diameter and the volume-average particle diameter of hydrophobic wet process silica and hydrophobic particulate wet process silica were measured in the same way as described above except that “ion-exchanged water” was changed to “2-propanol” and that the refractive index of the dispersion medium was changed from “1.33” to “1.37.”

### <Measurement of M Value (Methanol Wettability)>

The M value (methanol wettability) of hydrophobic wet process silica and hydrophobic particulate wet process silica was measured by the following method.

Water/methanol mixed solutions with methanol concentrations varied in 1% by volume intervals were prepared, and 0.2 g of a sample to be measured was put in a 10-ml test tube containing a water/methanol mixed solution (5 ml) having a certain concentration. The test tube was sealed, inverted 20 times, and then allowed to stand. The methanol concentration (% by volume) of the mixed solution having the minimum methanol concentration among the mixed solutions which contained no aggregates of the sample to be measured and in which the sample to be measured had been wetted entirely and mixed homogeneously was defined as an M value (methanol wettability).

### Example 1

### (Dry Hydrophobization Treatment 1)

A Henschel mixer equipped with a heater (UM-2E, manufactured by MITSUI MIIKE MACHINERY Co., Ltd.) was charged with 100 parts of hydrophilic wet process silica (hs1) {gel-processed silica having a number-average particle diameter of 1 μm, Nipgel AZ-204, manufactured by Tosoh Silica Corporation), and then 8 parts of a hydrophobizing agent (still) heated and melted at 75° C. {stearic acid, extra pure reagent, manufactured by KANTO CHEMICAL CO., INC.) was sprayed under low speed stirring (750 rpm). Subsequently, stirring at high speed rotation (2000 rpm) was performed for 15 minutes while heating the Henschel mixer at 70 to 75° C. with the heater, and thus the mixture was mixed uniformly. Subsequently, the Henschel mixer was heated at 180° C. with the heater with the stirring speed maintained, and mixing and heating treatment was performed at 180° C. for 3 hours, and thus hydrophobic wet process silica (ps1) was obtained. The hydrophobic wet process silica (ps1) had a number-average particle diameter (D0) of 1 μm and an M value of 55.

### (Wet Milling Treatment 1)

A container made of stainless steel was charged with 108 parts of hydrophobic wet process silica (ps1) and 10000 parts of an oily component (oc1) {edible soybean oil having a kinematic viscosity (at 40° C.) of 32 mm²/s, manufactured by Nisshin Oillio Group, Ltd.}, which were then stirred and mixed with a homogenizer (HIFLEX DISPERSER HG-92G, manufactured by TAITEC Corporation) at 4000 rpm, and thus a dispersion liquid (pd1) containing hydrophobic wet process silica (sp1) was obtained. Then, the dispersion liquid (pd1) was subjected to wet milling treatment at a rotor speed of 4000 rpm for 10 minutes by using a wet medium type milling device {DISPERMAT SL-C-12, manufactured by VMA-GETAMANN GMBH; the same applies hereinafter} filled with 100 ml of zirconia beads having a diameter of 0.7 mm, and thus a dispersion liquid (fd1) containing hydrophobic particulate wet process silica (fs1) was obtained.

### (Isolation Treatment 1 of Hydrophobic Particulate Wet Process Silica)

20 parts of the dispersion liquid (fd1) was subjected to centrifugation (centrifugal acceleration: 1619 G, for 10 minutes) and the supernatant was discarded. Then, 80 parts of hexane {extra pure reagent manufactured by KANTO CHEMICAL CO., INC.} was added and stirred and mixed with a propeller type stirrer, and then the supernatant was discarded. Then, operations of stirring and mixing with 80 parts of hexane, centrifugation, and discard of supernatant were repeated 4 times, followed by drying for 6 hours in a fair wind drier controlled at 100° C., and thus hydrophobic particulate wet process silica (fs1) was obtained. The hydrophobic particulate wet process silica (fs1) had a number-average particle diameter (Dn) of 0.1 μm, a volume-average particle diameter (Dv) of 0.4 μm, a (Dv/Dn) ratio of 4, and an M value of 50.

### Example 2

### (Wet Hydrophobization Treatment 1)

A container capable of heating, stirring and cooling containing 10000 parts of an oily component (oc2) {silicone oil, KF96-50cs, manufactured by Shin-Etsu Chemical Co., Ltd.} was charged with 100 parts of hydrophilic wet process silica (hs1) and 3 parts of a hydrophobizing agent (sm2) {decyltriethoxysilane, trade name: KBM-3103, produced by Shin-Etsu Chemical Co., Ltd.} in order under stirring and the temperature was increased to 110° C. under stirring. Heating and stirring were continued at this temperature for 3 hours, and thus a dispersion liquid (pd2) containing hydrophobic wet process silica (ps2) was obtained.

### (Isolation Treatment 1 of Hydrophobic Wet Process Silica)

Hydrophobic wet process silica (ps2) was obtained in the same manner as in Example 1 (Isolation Treatment 1 of Hydrophobic Particulate Wet Process Silica) except that 20 parts of the dispersion liquid (fd1) was changed to 20 parts of a dispersion liquid (pd2), and then the number-average particle diameter (D0) and the M value of the hydrophobic wet process silica (pd2) were measured to be 1 μm and 60, respectively.

### (Wet Milling Treatment 2)

The dispersion liquid (pd2) containing hydrophobic wet process silica (sp2) was subjected to wet milling treatment at a rotor speed of 4000 rpm for 10 minutes by using a wet medium type milling device [DISPERMAT SL-C-12, manufactured by VMA-GETAMANN GMBH; the same applies hereinafter} filled with 100 ml of zirconia beads having a diameter of 0.7 mm, and thus a dispersion liquid (fd2) containing hydrophobic particulate wet process silica (fs2) was obtained.

### (Isolation Treatment 2 of Hydrophobic Particulate Wet Process Silica)

Hydrophobic particulate wet process silica (fs2) was obtained by performing isolation treatment of hydrophobic particulate wet process silica in the same manner as in Example 1 (Isolation Treatment 1 of Hydrophobic Particulate Wet Process Silica) except that 20 parts of the dispersion liquid (fd1) was changed to 20 parts of a dispersion liquid (fd2). The hydrophobic particulate wet process silica (fs2) had a number-average particle diameter (Dn) of 0.2 μm, a volume-average particle diameter (Dv) of 0.9 μm, a (Dv/Dn) ratio of 4.5, and an M value of 53.

### Example 3

### (Wet Milling Treatment 3)

A container made of stainless steel was charged with 100 parts of hydrophilic wet process silica (hs2) {precipitated wet process silica having a number-average particle diameter (D0) of 40 μm, Sipernat 50manufactured by Evonik Degussa Japan Co., Ltd.} and 10000 parts of an oily component (oc2), which were then stirred and mixed with a homogenizer (HIFLEX DISPERSER HG-92G, manufactured by TAITEC Corporation) at 4000 rpm. Subsequently, wet milling treatment was performed at a rotor speed of 4000 rpm for 30 minutes by using a wet medium type milling device filled with 100 ml of zirconia beads having a diameter of 0.7 mm and thus a dispersion liquid (hd3) containing hydrophilic particulate wet process silica (fhs3) was obtained.

### (Wet Hydrophobization Treatment 3)

A container capable of heating, stirring and cooling was charged with 10100 parts of the dispersion liquid (hd3) and then 40 parts of a hydrophobizing agent (sm2) was added under stirring and the temperature was increased to 110° C. under stirring. Heating and stirring were continued at this temperature for 3 hours, and thus a dispersion liquid (fd3) containing hydrophobic particulate wet process silica (fs3) was obtained.

### (Isolation Treatment 3 of Hydrophobic Particulate Wet Process Silica)

Hydrophobic particulate wet process silica (fs3) was obtained by performing isolation treatment of hydrophobic particulate wet process silica in the same manner as in Example 1 (Isolation Treatment 1 of Hydrophobic Particulate Wet Process Silica) except that 20 parts of the dispersion liquid (fd1) was changed to 20 parts of a dispersion liquid (fd3). The hydrophobic particulate wet process silica (fs3) had a number-average particle diameter (Dn) of 1 μm, a volume-average particle diameter (Dv) of 3.5 μm, a (Dv/Dn) ratio of 3.5, and an M value of 80.

### Example 4

A dispersion liquid (pd4) containing hydrophobic wet process silica (ps4) and hydrophobic wet process silica (ps4) were obtained by performing wet. hydrophohization treatment and isolation treatment of hydrophobic wet process silica in the same manner as in Example 2 except that 10000 parts of the oily component (oc2) was changed to 400 parts of an oily component (oc3) {mineral oil having a kinematic viscosity of 21 mm²/s, COSMO SC22, manufactured by Cosmo Oil Lubricants Co., Ltd.}, that 100 parts of the hydrophilic wet process silica (hs1) was changed to 100 parts of hydrophilic wet process silica (hs2), and that 3 parts of the hydrophobizing agent (sm2) was changed to 2 parts of the hydrophobizing agent (sm2). The hydrophobic wet process silica (ps4) had a number-average particle diameter (D0) of 40 μm and an M value of 54.

Subsequently, a dispersion liquid (fd4) containing hydrophobic particulate wet process silica (fs4) was obtained by performing wet milling treatment in the same manner as in Example 2 except that the dispersion liquid (pd2) was changed to a dispersion liquid (pd4) and that the time was changed from 10 minutes to 15 minutes.

Hydrophobic particulate wet process silica (fs4) was obtained by performing isolation treatment of hydrophobic particulate wet process silica in the same manner as in Example 1 isolation Treatment 1 of Hydrophobic Particulate Wet Process Silica) except that 20 parts of the dispersion liquid (fd1) was changed to 20 parts of a dispersion liquid (fd4). The hydrophobic particulate wet process silica (fs4) had a number-average particle diameter (Dn) of 0.6 μm, a volume-average particle diameter (Dv) of 2.5 μm, a (Dv/Dn) ratio of 4, and an M value of 50.

### Example 5

A dispersion liquid (pd5) containing hydrophobic wet proceq silica (ps5) and hydrophobic wet process silica (ps5) were obtained by performing wet hydrophobization treatment and isolation treatment of hydrophobic wet process silica in the same manner as in Example 2 except that 10000 parts of the oily component (oc2) was changed to 2000 parts of the oily component (oc2), that 100 parts of the hydrophilic wet process silica (hs1) was changed to 100 parts of hydrophilic wet process silica (hs3) {precipitated wet process silica having a number-average particle diameter of 2 μm, Nipsil G300, manufactured by TOSOH SILICA CORPORATION}, that 3 parts of the hydrophobizing agent (sm2) was changed to 10 parts of a hydrophobizing agent (sm3) {methylhydrogenpolysiloxane, SH1007, manufactured by Shin-Etsu Chemical Co., Ltd.}, and that the heating temperature was changed from 110° C. to 180° C. The hydrophobic wet process silica (ps5) had a number-average particle diameter (D0) of 2 μm and an M value of 60.

Subsequently, a dispersion liquid (fd5) containing hydrophobic particulate wet process silica (fs5) was obtained by performing wet milling treatment in the same manner as in Example 2 except that the dispersion liquid (pd2) was changed to a dispersion liquid (pd5) and that the time was changed from 10 minutes to 40 minutes.

Hydrophobic particulate wet process silica (fs5) was obtained by performing isolation treatment of hydrophobic particulate wet process silica in the same manner as in Example 1 (Isolation Treatment 1 of Hydrophobic Particulate Wet Process Silica) except that 20 parts of the dispersion liquid (fd1) was changed to 20 parts of a dispersion liquid (fd5). The hydrophobic particulate wet process silica (fs5) had a number-average particle diameter (Dn) of 0.4 μm, a volume-average particle diameter (Dv) of 1 μm, a (Dv/Dn) ratio of 2.5, and an M value of 55.

### Example 6

A dispersion liquid (pd6) containing hydrophobic wet process silica (ps6) and hydrophobic wet process silica (ps6) were obtained by performing wet hydrophobization treatment and isolation treatment of hydrophobic wet process silica in the same manner as in Example 2 except that 10000 parts of the oily component (oc2) was changed to 550 parts of an oily component (oc3), that 100 parts of the hydrophilic wet process silica (hs1) was changed to 100 parts of hydrophilic we process silica (hs4) {precipitated wet process silica having a number-average particle diameter of 9 μm, Nipsil NA, manufactured by TOSOH SILICA CORPORATION}, and that 3 parts of the hydrophobizing agent (sm2) was changed to 25 parts of a hydrophobizing agent (sm3). The hydrophobic wet process silica (ps6) had a number-average particle diameter (D0) of 9 μm and an M value of 76.

Subsequently, a dispersion liquid (fd6) containing hydrophobic particulate wet process silica (fs6) was obtained by performing wet milling treatment in the same manner as in Example 2 except that the dispersion liquid (pd2) was changed to a dispersion liquid (pd6) and that the time was changed from 10 minutes to 45 minutes.

Hydrophobic particulate wet process silica (fs6) was obtained by performing isolation treatment of hydrophobic particulate wet process silica in the same manner as in Example 1 (Isolation Treatment 1 of Hydrophobic Particulate Wet Process Silica) except that 20 parts of the dispersion liquid (fd1) was changed to 20 parts of a dispersion liquid (fd6). The hydrophobic particulate wet process silica (fs6) had a number-average particle diameter (Dn) of 0.2 μm, a volume-average particle diameter (Dv) of 0.6 μm, a (Dv/Dn) ratio of 3, and an M value of 70.

### Example 7

A dispersion liquid (pd7) containing hydrophobic wet process silica (ps7) and hydrophobic wet process silica (ps7) were obtained by performing wet hydrophobization treatment and isolation treatment of hydrophobic wet process silica in the same manner as in Example 2 except that 10000 parts of the oily component (oc2) was changed to 550 parts of an oily component (oc3), that 100 parts of the hydrophilic wet process silica (hs1) was changed to 100 parts of hydrophilic wet process silica (hs3), and that 3 parts of the hydrophobizing agent (sm2) was changed to 15 parts of a hydrophobizing agent (sm3). The hydrophobic wet process silica (ps7) had a number-average particle diameter (D0) of 2 μm and an M value of 76.

Subsequently, a dispersion liquid (fd7) containing hydrophobic particulate wet process silica (fs7) was obtained by performing wet milling treatment in the same manner as in Example 2 except that the dispersion liquid (pd2) was changed to a dispersion liquid (pd7) and that the time was changed from 10 minutes to 90 minutes.

Hydrophobic particulate wet process silica (fs7) was obtained by performing isolation treatment of hydrophobic particulate wet process silica in the same manner as in Example 1 (Isolation Treatment 1 of Hydrophobic Particulate Wet Process Silica) except that 20 parts of the dispersion liquid (fd1) was changed to 20 parts of a dispersion liquid (fd7). The hydrophobic particulate wet process silica (fs7) had a number-average particle diameter (Dn) of 0.4 μm, a volume-average particle diameter (Dv) of 0.4 μm, a (Dv/Dn) ratio of 1, and an M value of 72.

### Example 8

A dispersion liquid (pd8) containing hydrophobic wet process silica (ps8) and hydrophobic wet process silica (ps8) were obtained by performing wet hydrophobization treatment and isolation treatment of hydrophobic wet process silica in the same manner as in Example 2 except that 10000 parts of the oily component (oc2) was changed to 1000 parts of an oily component (oc3), that 100 parts of the hydrophilic wet process silica (hs1) was changed to 100 parts of hydrophilic wet process silica (hs5) {precipitated wet process silica having a number-average particle diameter of 20 μm, Sipernat 700 manufactured by Evonik Degussa Japan Co., Ltd.}, and that 3 parts of the hydrophobizing agent (sm2) was changed to 30 parts of a hydrophobizing agent (sm3). The hydrophobic wet process silica (ps8) had a number-average particle diameter (D0) of 20 μm and an M value of 80.

Subsequently, a dispersion liquid (fd8) containing hydrophobic particulate wet process silica (fs8) was obtained by performing wet milling treatment in the same manner as in Example 2 except that the dispersion liquid (pd2) was changed to a dispersion liquid (pd8) and that the time was changed from 10 minutes to 60 minutes.

Hydrophobic particulate wet process silica (fs8) was obtained by performing isolation treatment of hydrophobic particulate wet process silica in the same manner as in Example 1 (Isolation Treatment 1 of Hydrophobic Particulate Wet Process Silica) except that 20 parts of the dispersion liquid (fd1) was changed to 20 parts of a dispersion liquid (fd8). The hydrophobic particulate wet process silica (fs8) had a number-average particle diameter (Dn) of 0.4 μm, a volume-average particle diameter (Dv) of 0.5 μm, a (Dv/Dn) ratio of 1.3, and an M value of 76.

### <Evaluation 1>

Hydrophobic particulate wet process silica (fs1) to (fs8) were evaluated as follows as a mechanical strength enhancer for resin.

Moreover, comparative hydrophobic silica (hps1) {fumed silica having a number-average particle diameter of 0.2 μm and an M value of 75, AEROSIL RX-200, manufactured by Nippon Aerosil Co., Ltd.; AEROSIL is a registered trademark of Evonik Degussa GMBH} and comparative hydrophobic silica (hps2) {hydrophobic precipitated silica having a number-average particle diameter of 2 μm and an M value of 65, Nipsil S510, manufactured by Tosoh Silica Corporation} were also evaluated, as follows (Comparative Examples1 and 2, in order).

90 parts of a high impact polystyrene (PS) resin {HIPS 433, manufactured by PS Japan Corporation} and 10 parts of a sample (hydrophobic particulate wet process silica or comparative hydrophobic silica) were mixed with a Henschel mixer {manufactured by Mitsui Mining Co., Ltd.} for 20 minutes and then kneaded with a twin screw extruder (Laho Plastomill M type, manufactured by Toyo Seiki Seisaku-sho, Ltd.) at a cylinder temperature of 220° C. for a residence time of 5 minutes, and thus a resin composition was obtained. From the resin composition, a molded specimen was produced under conditions including a cylinder temperature of 230° C. and a mold temperature of 50° C. by the use of an injection molding machine {PS40E5ASE, manufactured by NISSEI PLASTIC INDUSTRIAL CO., LTD.}, and the 60° gloss (surface gloss value) and the Izod impact strength of the specimen were measured and shown in Table 1.

In addition, a specimen containing no mechanical strength enhancer (hydrophobic particulate wet process silica or comparative hydrophobic silica) was produced similarly and it was evaluated as a blank.

The surface gloss value was measured with a gloss meter in accordance with ISO 2813: 1994 (DM26D manufactured by Murakami Color Research Laboratory Co., Ltd.), and the Izod impact strength was measured in accordance with ASTM D256, Method A (with a notch 3.2 mm thick).

TABLE 1

| | | Surface gloss | Izod impact |
|---|---|---|---|
| | | value (%) | strength (J/m) |
| Example | 1 | 90 | 84 |
| | 2 | 91 | 85 |
| | 3 | 91 | 83 |
| | 4 | 92 | 83 |
| | 5 | 93 | 84 |
| | 6 | 93 | 85 |
| | 7 | 93 | 86 |
| | 8 | 94 | 86 |
| Comparative | 1 | 90 | 79 |
| Example | 2 | 80 | 86 |
| Blank | | 95 | 78 |

### <Evaluation 2>

Hydrophobic particulate wet process silica (fs1) to (fs8) and comparative hydrophobic silica (hps1) to (hps2) (Examples 1 to 8 and Comparative Examples 1 and 2, in order) were evaluated as a fluidizing agent of powder paint as follows.

(A) 100 parts of bisphenol A type epoxy resin (a) (“EPIKOTE 1055”, epoxy equivalent; 850, number average molecular weight=1600, manufactured by Japan Epoxy Resin Co., Ltd.; “EPIKOTE” is a registered trademark of Resolution Research Netherland Besloten Vennootschap) as an epoxy resin, (B) 15 parts of dicyandiamide (special grade reagent manufactured by Tokyo Chemical Industry Co., Ltd.), and (C) 5 parts of adipic acid dihydrazide (“ADH” manufactured by Nippon Kasei Chemical Co., Ltd.) were mixed with a Henschel mixer {manufactured by Mitsui Mining Co., Ltd.} for 20 minutes and then kneaded with a bench melt kneading device (Labo Plastomill, manufactured by Toyo Seiki Seisaku-sho, Ltd.). Subsequently, the kneadate was milled with an air stream type milling device {jet mill, manufactured by Hosokawa Micron Corp.}, and a paint resin particle was prepared. Then, 99 parts of the paint resin particle and 1 part by weight of a sample (hydrophobic particulate wet process silica) were dry mixed with a Henschel mixer, and a powder paint was obtained.

The powder paint was applied to a tin plate (12.5×12.5×50 mm) with an electrostatic fluidized bed coating apparatus such that the coating film would have a thickness of about 200 μm at its flat part, and then was heated and cured at 190° C. for 15 minutes, and thus a coating film for evaluation was prepared.

The 60° gloss (surface gloss value) of the coating film far evaluation was measured with a gloss meter in accordance with ISO 2813: 1994 (DM96D manufactured by Murakami Color Research Laboratory Co., Ltd.) and was shown in Table 2.

TABLE 2

| | | Surface gloss |
|---|---|---|
| | | value (%) |
| Example | 1 | 76 |
| | 2 | 80 |
| | 3 | 78 |
| | 4 | 85 |
| | 5 | 85 |
| | 6 | 92 |
| | 7 | 92 |
| | 8 | 88 |
| Comparative | 1 | 70 |
| Example | 2 | 60 |

### Production Example 1

In a container capable of heating, stirring, and cooling, 5 parts of a nucleating agent (k1) {ethylenebisstearylamide, ALFLOW H-50S, manufactured by NOF Corporation} and 95 parts of an oily component (oc4) {mineral oil having a kinematic viscosity (at 40° C. of 10 mm²/s COSMO RC SPINDLE OIL, manufactured by Cosmo Oil Lubricants Co., Ltd.} were heated to 150° C. under heating and stirring, and heating and stirring were continued at this temperature for 15 minutes. Subsequently, after cooling to 25° C. under stirring, homogenization was performed at 3500 psi (24.1 MPa) by using a Gaulin Homogenizer, and thus, a nucleating agent-containing oily component (ko1) was obtained.

### Production Example 2

A nucleating agent-containing oily component (Ko2) was prepared in the same manner as in Production Example 1except that 4 parts of the nucleating agent (k1) was changed to 10 parts of a nucleating agent (k2) oxidized polyethylene wax, EPOLENE E-10, manufactured by Eastman Chemical Company} and 95 parts of the oily component (oc4) was changed to 90 parts of the oily component (oc4).

### Production Example 3

A nucleating agent-containing oily component (Ko3) was prepared in the same manner as in Production Example 1 except that 4 parts of the nucleating agent (k1) was changed to 10 parts of a nucleating agent (k3) {aluminum stearate, SA-1500, manufactured by Sakai Chemical Industry Co., Ltd.} and 95 parts of the oily component (oc4) was changed to 90 parts of the oily component (oc4).

### Production Example 4

A nucleating agent-containing oily component (ko4) was obtained by stirring 20 parts of a nucleating agent (k4) {hydrophilic fumed silica, Aerosil 200, manufactured by Nippon Aerosil Co., Ltd.} and 80 parts of an oily component (oc4) for 15 minutes in a container capable of stirring.

### Production Example 5

A four-neck flask equipped with a temperature controller, stirring blades, a dropping pump, a pressure reducing device, a Dimroth condenser, a nitrogen inlet, and a nitrogen outlet was charged with 214.6 parts of a polyol (PL-1) {a polyol prepared by adding PO (14 mol), EO (1 mol) and PO (1 mol) in order to glycerin (1 mol), having a hydroxyl value of 56, an EO content of 4.4% by weight, and a PO content of 80.5% by weight (PO and EO mean propylene oxide and ethylene oxide, respectively; the same applies hereinafter)}, 61.6 parts of ion-exchanged water, and 21 parts of a dispersing agent (DA) {a reactive dispersing agent prepared by chemically reacting 0.14 mol of a polyol prepared by adding PO (23.6 mol) and EO (5.6 mol) in order to pentaerythritol (1 mol) and having a hydroxyl value of 32, a PO content of 78% by weight and an EO content of 14% by weight, 0.07 mol of 2-hydroxymethacrylate, and 0.16 mol of toluene diisocyanate, and having a hydroxyl value of 20 and a the number of unsaturated groups/the number of nitrogen-containing groups ratio of 0.22}, followed by replacement with nitrogen, and then the temperature was raised to 130° C. under stirring in a nitrogen atmosphere (until the completion of polymerization). Subsequently, a monomer-containing mixed liquid prepared by pre-mixing 77.7 parts of a polyol (PL-1), 84.0 parts of acrylonitrile (manufactured by KANTO CHEMICAL CO., INC., extra pure reagent), 19(10 parts of styrene (manufactured by KANTO CHEMICAL CO., INC., extra pure reagent), 0.3 parts of divinylbenzene (manufactured by KANTO CHEMICAL, CO., INC., extra pure reagent), 33.6 parts of a dispersing agent (DA), 8.4 parts of ion-exchanged water, and 2.8 parts of a radical polymerization initiator (2,2′-azobis(2-methylbutyronitrile), trade name “V-59”, manufactured by Wako Pure Chemical Industries, Ltd.) was dropped continuously at a rate of 2 parts/minute using a dropping pump, and after the completion of the dropping, polymerization was performed at 130° C. for 240 minutes. Subsequently, after feeding 70 parts of the polyol (PL-1), the unreacted monomer was stripped off at 2,666 to 3,999 Pa (20 to 30 torr) for 2 hours at 130 to 140° C. under reduced pressure, and thus, a polymer polyol (PO-1) containing 39% by weight of acrylonitrile/styrene copolymerized particles was obtained.

Then, a nucleating agent-containing oily component (ko5) was obtained by stirring 66 parts of polymer polyols (PO-1) and 34 parts of an oily component (oc4) for 15 minutes.

### Example 9

A defoaming agent (DF1) of the present invention was obtained by stirring and mixing 800 parts of a dispersion liquid (fd1) and 200 parts of the nucleating agent-containing oily component (ko1) for 15 minutes in a container capable of stirring.

### Example 10 to 17, Comparative Example 3 to 4

Inventive defoaming agents (DF2) to (DF9) and comparative defoaming agents (HDF1) to (HDF2) were obtained in the same manner as in Example 9 (that is, by stirring and mixing constituents for 15 minutes) except that the dispersion liquid (fd1) and the nucleating agent-containing oily component (ko1) were changed in type and used amount as shown m Table 3.

TABLE 3

| | | | | | | | | | | Comparative | |
|---|---|---|---|---|---|---|---|---|---|---|---|
| | Example | | | | | | | | | Example | |
| | 9 | 10 | 11 | 12 | 13 | 14 | 15 | 16 | 17 | 3 | 4 |
| Defoaming | DF1 | DF2 | DF3 | DF4 | DF5 | DF6 | DF7 | DF8 | DF9 | HDF1 | HDF2 |
| agent | | | | | | | | | | | |
| Dispersion liquid (fd1) | 800 | 100 | | | | | | | | | |
| Dispersion liquid (fd2) | | | 100 | | | | | | | | |
| Dispersion liquid (fd3) | | | | 100 | | | | | | | |
| Dispersion liquid (fd4) | | | | | 100 | | | | | | |
| Dispersion liquid (fd5) | | | | | | 100 | | | | | |
| Dispersion liquid (fd6) | | | | | | | 100 | | | | |
| Dispersion liquid (fd7) | | | | | | | | 100 | | | |
| Dispersion liquid (fd8) | | | | | | | | | 100 | | |
| Nucleating agent-containing | 200 | | | | | 50 | 100 | 150 | 100 | 2 | |
| oily component (ko1) | | | | | | | | | | | |
| Nucleating agent-containing | | | | 1 | | | | | | | |
| oily component (ko2) | | | | | | | | | | | |
| Nucleating agent-containing | | | | | 40 | | | | | | |
| oily component (ko3) | | | | | | | | | | | |
| Nucleating agent-containing | | | 35 | | | | | | | | |
| oily component (ko4) | | | | | | | | | | | |
| Nucleating agent-containing | | | 35 | | | | | | | | |
| oily component (ko5) | | | | | | | | | | | |
| Oily component (oc4) | | 350 | | 30 | 70 | 350 | 100 | | 50 | 95 | 95 |
| Hydrophobic silica (hps1) | | | | | 50 | | | | | 5 | |
| Hydrophobic silica (hps2) | | | | | | | | | | | 5 |
| Polyether compound (pe3) | | 350 | | | | | 7 | | 5 | | 10 |
| Ion-exchanged water | | | 200 | 10 | | | | | | | |

Oily component (oc4): Mineral oil having a kinematic viscosity at 40° C.) of 10 mm²/s, COSMO RC SPINDLE OIL, manufactured by Cosmo Oil Lubricants Co., Ltd.
Hydrophobic silica (hps1): Fumed silica having a number-average particle diameter of 0.2 μm and an M value of 75, AEROSIL RX-200, manufactured by Nippon Aerosil Co., Ltd.
Hydrophobic silica (hps2): Hydrophobic precipitated silica having a number-average particle diameter of 2 μm and an M value of 65. Nipsil 5510, manufactured by Tosoh Silica Corporation
Polyether compound (pe3): Stearic acid diester of polyoxyethylene(5 mol)polyoxypropylene(30 mol)

### <Evaluation 3>

Using the inventive defoaming agents (DF1) to (DF9) and the comparative defoaming agents (HDF1) to (HDF2) obtained in Examples and Comparative Examples, emulsion paints were prepared and then the defoaming property for the emulsion paints and the gloss of resulting coating films were evaluated, and the evaluation results were shown in Table 5.

### (Preparation of Emulsion Base Paint)

Grinding and letting down were performed with the following raw material compositions provided in Table 4 by using an EXCEL-AUTO HOMOGENIZER (Nihonseiki Co., Ltd., Model ED) equipped with an impeller-type blade to prepare an emulsion base paint.

TABLE 4

| | | | | |
|---|---|---|---|---|
| Grinding step | Water | 14.1 | parts | |
| | SN-Dispersant 5040 | 1.2 | parts | Note 1 |
| | HEC (SP-600) | 0.1 | parts | Note 2 |
| | SN-WET L | 0.3 | parts | Note 3 |
| | SN-WET 970 | 0.6 | parts | Note 4 |
| | Aqueous ammonia solution | 0.2 | parts | |
| | (25% by weight) | | | |
| | SUN LIGHT SL-300 | 12.4 | parts | Note 5 |
| | TIPAQUE R820 | 34.2 | parts | Note 6 |
| Letting down step | ACRONAL 295DN | 31.1 | parts | Note 7 |
| | TEXANOL | 2.2 | parts | Note 8 |
| | Water | 3.6 | parts | |

| | | |
|---|---|---|
| Total | 100.0 | parts |

Note 1:
Dispersant manufactured by San Nopco Ltd.
Note 2:
Thickener manufactured by Daicel FineChem Ltd.
Note 3:
Wetting agent manufactured by San Nopco Ltd.
Note 4:
Wetting agent manufactured by San Nopco Ltd.
Note 5:
Calcium carbonate manufactured by Takehara Kagaku Kogyo Co., Ltd.
Note 6:
Titanium dioxide manufactured by Ishihara Sangyo Kaisha, Ltd.
Note 7:
Acrylic emulsion manufactured by BASF A.G.; “ACRONAL” is a registered trademark of BASF Aktiengesellschaft.
Note 8:
Film conditioner manufactured by Eastman Chemical Company; “TEXANOL” is a registered trademark of Yoshimura Oil Chemical Co., Ltd.

### (Preparation of Emulsion Paint)

Defoaming agents (DF1) to (DF9) or comparative defoaming agents (HDF1) to (HDF2) were added to emulsion-based paints each such that the added amount of the portion excluding water would be 0.3% by weight (based on the emulsion-based paint), and were stirred and mixed at 25° C. 4000 rpm, for 3 minutes with an Excel Auto Homogenizer equipped with a colles-type blade, and thus emulsion paints for evaluation were obtained.

In addition, a blank emulsion paint was obtained in the same manner as above except that no defoaming agent was added.

### (Defoaming Property)

An emulsion paint for evaluation or an emulsion paint for blank was applied to a tin plate in a square of 15 cm on each side with a middle-napped wool roller paint (manufactured by Ohtsuka Brush Mfg. Co., Ltd.), and then the initial defoaming property and the defoaming rate were evaluated and the results were shown in Table 5.

The initial defoaming property was assessed by the number of bubbles visually observable immediately after application, and a smaller number means that the initial defoaming property of the defoaming agent is better. The defoaming rate was assessed by a time taken until no foam was observable, and a smaller value thereof means that the defoaming rate is fast and better.

### (Gloss Property)

An emulsion paint for evaluation was applied to a glass plate with an applicator with a gap of 125 μm in accordance with JIS K5960: 2003, Household Paint for Interior Wall, Appendix 2 (Regulation) Applicator Coating. For the coating film after drying for 1 day, 60° gloss was measured at three points with a gloss meter in accordance with ISO 2813: 1994 (DM26D, manufactured by Murakami Color Research Laboratory Co., Ltd.), and an average value was calculated. The blank emulsion paint was also applied in the same manner and then 60° gloss was measured. The ratio of the average gloss value of an emulsion paint for evaluation to the average gloss value of the blank emulsion paint (percentage: (the gloss value of the emulsion paint for evaluation)/(the gloss value of the blank emulsion paint)×100) was calculated and shown as gloss property in Table 5.

The closer to 100 the ratio, the less the deterioration in gloss and the better the gloss property.

TABLE 5

| | | | | | | | | | | | Comparative | |
|---|---|---|---|---|---|---|---|---|---|---|---|---|
| | | Example | | | | | | | | | Example | |
| | | 9 | 10 | 11 | 12 | 13 | 14 | 15 | 16 | 17 | 3 | 4 |
| Defoaming agent | | DF1 | DF2 | DF3 | DF4 | DF5 | DF6 | DF7 | DF8 | DF9 | HDF1 | HDF2 |
| Defoaming | Initial defoaming | 5 | 5 | 4 | 4 | 4 | 1 | 1 | 0 | 1 | 12 | 8 |
| property | property (foam) | | | | | | | | | | | |
| | Defoaming rate | 42 | 45 | 40 | 38 | 40 | 15 | 17 | 0 | 13 | 60 or | 55 |
| | (second) | | | | | | | | | | more | |

| | | | | | | | | | | | |
|---|---|---|---|---|---|---|---|---|---|---|---|
| Gloss property | 81 | 82 | 83 | 86 | 88 | 90 | 92 | 94 | 93 | 80 | 78 |

As being apparent from the results shown above, the hydrophobic particulate wet process silica (fs1) to (fs8) of the present invention were superior in the surface gloss property of resin as compared with Comparative Examples 1 to 2 even in use as a mechanical strength enhancer for resin <Evaluation 1>, and they were superior in the gloss property of a coating film even in use as a fluidizing agent for powder paint <Evaluation 2>. In addition, the defoaming agents (DF1) to (DF9) of the present invention containing the hydrophobic particulate wet process silica (fs1) to (fs8) of the present invention were superior in defoaming property and gloss property as compared with the comparative defoaming agents (hdf1) to (hdf2) <Evaluation 3>. Especially, the defoaming agents (DF6) to (DF9) containing hydrophobic particulate wet process silica (fs5) to (fs8) were good in both defoaming property and gloss property.

### INDUSTRIAL APPLICABILITY

The hydrophobic particulate silica of the present invention can be used suitably as a wear resistance improver or a mechanical strength enhancer for resin, a fluidizing agent for powder paint, etc.

The defoaming agent of the present invention is suitable especially as a defoaming agent for ink and a defoaming agent for paint (aqueous paint, etc.).

1. Hydrophobic particulate wet process silica resulting from subjecting hydrophilic wet process silica to hydrophobization treatment and milling treatment, wherein the number-average particle diameter (Dn) is 0.1 to 1 μm and the M value is 50 to 80.

2. The hydrophobic particulate wet process silica according to claim 1, wherein the milling treatment is wet milling treatment.

3. The hydrophobic particulate wet process silica according to claim 1, wherein the hydrophobization treatment is wet hydrophobization treatment.

4. The hydrophobic particulate wet process silica according to claim 1, wherein the ratio of the volume-average particle diameter (Dv) to the number-average particle diameter (Dn) (Dv/Dn) is 1 to 4.

5. A method for producing the hydrophobic particulate wet process silica according to claim 1, the method comprising:
process (A) comprising hydrophobization treatment step (1) of obtaining hydrophobic wet process silica by subjecting hydrophilic wet process silica to hydrophobization treatment and milling step (2) of obtaining hydrophobic particulate wet process silica by milling the hydrophobic wet process silica; or
process (B) comprising milling step (3) of obtaining hydrophilic particulate wet process silica by milling hydrophilic wet process silica and hydrophobization treatment step (4) of obtaining hydrophobic particulate wet process silica by subjecting the hydrophilic particulate wet process silica to hydrophobization treatment.

6. The production method according to claim 5, wherein the hydrophobization treatment step (1) is a step of dispersing hydrophilic wet process silica in an oily component, thereby obtaining a dispersion liquid, and then performing hydrophobization treatment, thereby obtaining hydrophobic wet process silica.

7. The production method according to claim 5, wherein the milling step (2) is a step of obtaining hydrophobic particulate wet process silica by milling hydrophobic wet process silica in an oily component.

8. The production method according to claim 5, wherein the milling step (3) is a step of dispersing hydrophilic wet process silica in an oily component, thereby obtaining a dispersion liquid, and then milling hydrophilic wet process silica in an oily component, thereby obtaining hydrophilic particulate wet process silica.

9. The production method according to claim 5, wherein the hydrophobization treatment step (4) is a step of obtaining hydrophobic particulate wet process silica by subjecting hydrophilic particulate wet process silica to hydrophobization treatment in an oily component.

10. The production method according to claim 5, wherein the number-average particle diameter of the hydrophilic wet process silica or the hydrophobic wet process silica is 1 to 40 μm.

11. The production method according to claim 5, wherein the ratio of the volume-average particle diameter (Dv) to the number-average particle diameter (Dn) (Dv/Dn) of the hydrophobic particulate wet process silica is 1 to 4.

12. The production method according to claim 5, wherein the number-average particle diameter (Dn) of the hydrophilic particulate wet process silica or the hydrophobic particulate wet process silica is 0.1 to 1 μm, and the ratio of the number-average particle diameter (Dn) of the hydrophilic particulate wet process silica or the hydrophobic particulate wet process silica to the number-average particle diameter (D0) of the hydrophilic wet process silica or the hydrophobic wet process silica (Dn/D0) is 0.01 to 0.2.

13. A defoaming agent comprising the hydrophobic particulate wet process silica according to claim 1, and an oily component.

14. A defoaming agent comprising hydrophobic particulate wet process silica obtained using the production method according to claim 5, and an oily component.

15. The defoaming agent according to claim 13, further comprising at least one nucleating agent selected from the group consisting of fatty acid metal salts, fatty acid amides, waxes, synthetic resins, and hydrophobic metal oxides.
